(19) United States
(12) Patent Application Publication
(10) Pub. No.: US 2026/0223849 A1
(43) Pub. Date: Aug. 6, 2026

(54) FUNGICIDAL COMBINATION

(71) Applicants: UPL MAURITIUS LIMITED, Port Louis (MU); UPL EUROPE SUPPLY CHAIN GMBH, Rotkreuz/Risch (CH)

(72) Inventors: Ronaldo Bueno Rodrigues, Campinas (BR); Ayrton Berger Neto, Campinas (BR); Jean Mary Zonato, Durham (BR)

(73) Assignees: UPL MAURITIUS LIMITED, Port Louis (MU); UPL EUROPE SUPPLY CHAIN GMBH, Rotkreuz/Risch (CH)

(21) Appl. No.: 19/154,932

(22) PCT Filed: Feb. 9, 2024
(86) PCT No.: PCT/EP2024/053303

§ 371 Date: Aug. 8, 2025

(30) Foreign Application Priority Data
Feb. 10, 2023 (EP) 23156145.7

(51) Int. Cl. A01N 43/56; A01N 43/653; A01N 47/26; A01P 3/00

(52) U.S. Cl. CPC A01N 43/56; A01N 43/653; A01N 47/26; A01P 3/00

(57) ABSTRACT

The present disclosure relates to a fungicidal combination for controlling phytopathogenic fungi in wheat crop. The present disclosure further relates to a fungicidal combination for controlling fungal infestation in wheat crop comprising at least one fungicide comprising fluxapyroxad, prothioconazole and mancozeb. The present disclosure particularly relates to a method of controlling fungal infestation in wheat crop.

### FIELD OF THE INVENTION

The present disclosure relates to a fungicidal combination for controlling phytopathogenic fungi in wheat crop. The present disclosure further relates to a method of controlling fungal diseases in wheat crop.

### BACKGROUND OF INVENTION

Wheat is a widely cultivated crop and is one of the primary staple foods. Of the thousands of known wheat varieties, the most important are common wheat (Triticum aestivum), durum wheat (T. durum), and club wheat (T. compactum). Wheat is cultivated as a cash crop, as it produces a good yield per unit area, grows well in a temperate climate with a moderately short growing season, and yields a versatile, high-quality flour.

Wheat is the second-most-produced cereal grain after maize, and the global trade of wheat is greater than all other crops combined. In 2020, the total global production of wheat was 760 million tons. China, India, and Russia are the three largest individual wheat producers in the world, accounting for about 41% of the world's total wheat production. United States is the fourth-largest individual wheat producer in the world. However, the European Union, if it were counted as a single country, its wheat production would exceed that of any country except China.

Tan spot (TS) also known as yellow leaf spot, is caused by the ascomycete fungal pathogen and occurs worldwide wherever wheat and other susceptible host crops are grown. Pyrenophora tritici-repentis (Ptr), (asexual stage: Drechslera tritici-repentis), an ascomycete fungus, is a necrotrophic pathogen causing tan spot, an important destructive foliar disease of wheat. Fungal infestation by the pathogen results in decreased kernel weight and numbers of grains per head. The fungus also can infect wheat spikes and eventually the kernels, causing a disease of the seeds known as red smudge. TS is found in most parts of the wheat-growing world, including Europe, North America and Australia. In Asia, this pathogen is a component of the Helminthosporium leaf blight complex. The rise of TS as a significant disease in affected areas has been attributed to the use of minimum or zero tillage practices. Disease surveys conducted in Australia in 2009 concluded that wheat TS was the primary cause of yield loss, costing the local wheat industry more than AU$200 million in losses per annum.

Wheat stripe (yellow rust) is caused by P. striiformis Westend. f. sp. tritici (Pst), a pathogen highly prevalent in temperate regions with cool and wet weather conditions. Stripe rust is currently the most economically important wheat rust disease with yield losses reaching 100% in susceptible cultivars. Approximately 88% of the world's wheat varieties are susceptible to Pst and global losses inflicted by the disease are nearly US$1 billion annually. In Australia, losses caused by stripe rust are estimated at AU$ 127 million. Therefore, there is a need to provide a solution to prevent fungal infestation and reduce yield loss.

Stripe (yellow) rust, caused by Puccinia striiformis f. sp. tritici (Pst), is a serious disease of wheat occurring in most wheat areas with cool and moist weather conditions during the growing season. The basidiomycete fungus is an obligate biotrophic parasite that is difficult to culture on artificial media. Pst is a macrocyclic, heteroecious fungus that requires both primary (wheat or grasses) and alternate (Berberis or Mahonia spp.) host plants to complete its life cycle. Uredinio spores have the capacity for wind dispersal over long distances, which may, under high inoculum pressure, extend to thousands of kilometres from the initial infection sites. Stripe rust is the current major rust disease affecting winter cereal production across the world. In India, it is a major disease in the Northern Hill Zone and the North-Western Plain zone and spreads easily during the onset of cool weather and when wind conditions are favourable. Yield loss from yellow rust in wheat can range from 5% to as high as 30% in high disease pressure scenarios (highly susceptible varieties in coastal regions/eastern counties). This loss result from rust colonies in the leaf, draining carbohydrate from the plant and reducing green leaf area. Severe infections result in poor root growth and drought susceptibility.

Fungicides act to protect plants against fungal damage. However, no one fungicide is useful in all situations and repeated usage of a single fungicide frequently leads to resistance development. Consequently, research is being conducted to use fungicides and their combinations for management of tan spot and yellow rust in wheat plants that are safer, that have better performance, that require lower dosages, that are easier to use, and that cost less and aid in resistance management of fungal infestation.

Prior art literature fails to provide an efficacious fungicidal combination for controlling phytopathogenic fungi causing infestation, particularly tan spot, leaf spot, and yellow rust which are main causes for deterioration in wheat crop yield and quality. It is also important to manage tan spot and yellow rust resistance under field conditions. Thus, there is an urgent need to provide a solution for controlling wheat diseases and to increase crop yield.

Fluxapyroxad (3-(difluoromethyl)-1-methyl-N-(3′,4′,5′-trifluorobiphenyl-2-yl) pyrazole-4-carboxamide) is a succinate dehydrogenase inhibitor (SDHI). Fluxapyroxad is a broad spectrum, pyrazole carboxamide fungicide commonly used for grains, row crops, vegetable crops, and fruit trees.

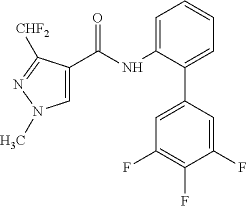 [SMILES: Cn1cc(C(=O)Nc2ccccc2-c2cc(F)c(F)c(F)c2)c(C(F)F)n1]

Prothioconazole (2-[2-(1-chlorocyclopropyl)-3-(2-chlorophenyl)-2-hydroxy propyl]-1,2-dihydro-3H-1,2,4-triazole-3-thione), is a broad-spectrum systemic fungicide. Prothioconazole is used for control of diseases caused by ascomycetes, basidiomycetes, and deuteromycetes.

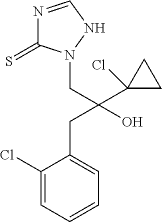 [SMILES: OC(Cc1ccccc1Cl)(Cn1[nH]cnc1=S)C1(Cl)CC1]

Mancozeb is a dithiocarbamate fungicide. It is the zinc ion coordination product with manganese ethylene-1,2-bisdithiocarbamate polymer, having the following chemical structure:

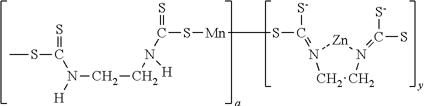

Mancozeb has a polymeric structure containing 1.6 percent zinc, in which 6% of the units are in the form of a coordination complex.

The present inventors have provided a combination and a method for controlling fungal diseases in wheat crop to prevent excessive damages caused by fungal infestation and to ameliorate crop yield and quality.

### SUMMARY OF THE INVENTION

In an aspect, the present disclosure relates to a fungicidal combination for controlling fungal infestation in wheat crop, the combination comprising;
(i) a succinate dehydrogenase inhibitor fungicide, and
(ii) a demethylation inhibitor fungicide.

In an aspect, the present disclosure relates to a fungicidal combination for controlling fungal infestation in wheat crop, the combination comprising fluxapyroxad and prothioconazole.

In another aspect, the present disclosure relates to a fungicidal combination for controlling fungal infestation in wheat crop, the combination comprising;
(i) a succinate dehydrogenase inhibitor fungicide,
(ii) a demethylation inhibitor fungicide, and
(iii) a multi-site fungicide.

In another aspect, the present disclosure relates to a fungicidal combination for controlling fungal infestation in wheat crop, the combination comprising fluxapyroxad, prothioconazole and mancozeb.

In an aspect, the present disclosure relates to a fungicidal composition for controlling fungal infestation in wheat crop, the combination comprising;
(i) a succinate dehydrogenase inhibitor fungicide,
(ii) a demethylation inhibitor fungicide, and
(iii) agrochemically acceptable excipients.

In an aspect, the present disclosure relates to a fungicidal composition for controlling fungal infestation in wheat crop, the combination comprising;
(i) a succinate dehydrogenase inhibitor fungicide,
(ii) a demethylation inhibitor fungicide,
(iii) a multi-site fungicide, and
(iv) agrochemically acceptable excipients.

In another aspect, the present disclosure relates to use of a fungicidal combination/combination for controlling fungal infestation in wheat crop, the combination/composition comprising fluxapyroxad and prothioconazole.

In another aspect, the present disclosure relates to use of a fungicidal combination/combination for controlling fungal infestation in wheat crop, the combination/composition comprising fluxapyroxad, prothioconazole and mancozeb.

In another aspect, the present disclosure relates to a method of controlling fungal infestation in wheat crop, the method comprising applying to a plant or a locus thereof a fungicidal combination/composition comprising;
(i) a succinate dehydrogenase inhibitor fungicide, and
(ii) a demethylation inhibitor fungicide.

In another aspect, the present disclosure relates to a method of controlling fungal infestation in wheat crop, the method comprising applying on a plant or a locus thereof a fungicidal combination/composition comprising fluxapyroxad and prothioconazole.

In another aspect, the present disclosure relates to a method of controlling fungal infestation in wheat crop, the method comprising applying on a plant or a locus thereof, a fungicidal combination/composition comprising;
(i) a succinate dehydrogenase inhibitor fungicide,
(ii) a demethylation inhibitor fungicide, and
(iii) a multi-site fungicide.

In another aspect, the present disclosure relates to a method of controlling fungal infestation in wheat crop, said method comprising applying on a plant or a locus thereof a fungicidal combination/composition comprising fluxapyroxad, prothioconazole and mancozeb.

In an aspect, the present disclosure relates to a kit of parts comprising a fungicide combination for controlling fungal infestation in wheat crop.

### DETAILED DESCRIPTION OF THE INVENTION

The present disclosure now will be described hereinafter with reference to the accompanying examples, in which embodiments of the disclosure are shown. This description is not intended to be a detailed catalogue of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from essence of the invention disclosed. Hence, the following descriptions are intended to illustrate some particular embodiments of the disclosure, and not to exhaustively specify all permutations, combinations and variations thereof.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the disclosure, suitable methods and materials are described herein.

It must be noted that, as used in this specification, the singular forms “a,” “an” and “the” include plural referents unless the content clearly dictates otherwise. The terms first, second etc., as used herein are not meant to denote any particular ordering, but simply for convenience to denote a plurality of, for example, layers. The terms “preferred” and “preferably” refer to embodiments of the disclosure that may afford certain benefits, under certain circumstances.

As used herein, the terms “comprising” “including,” “having,” “containing,” “involving,” and the like are to be understood to be open-ended, i.e., to mean including but not limited to.

As used herein, the term “about” or “approximately” is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10% or ±5% of the stated value.

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. As used herein, all numerical values or numerical ranges include integers within such ranges and fractions of the values or the integers within ranges unless the context clearly indicates otherwise. Thus, for example, reference to a range of 90-100%, includes 91%, 92%, 93%, 94%, 95%, 95%, 97%, etc., as well as 91.1%, 91.2%, 91.3%, 91.4%, 91.5%, etc., 92.1%, 92.2%, 92.3%, 92.4%, 92.5%, etc., and so forth. All methods described herein can be performed in a suitable order unless otherwise indicated herein or otherwise clearly contradicted by context.

The use of any examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

As used herein, the expression of various quantities in terms of “%” or “% w/v” or “% w/w” means the percentage by weight of the total solution or composition unless otherwise specified.

As used herein, the term “agrochemical” used herein is understood to denote an agricultural chemical such as pesticides, fungicides, insecticides, acaricides, herbicides, nematicides, plant growth regulators and can be used interchangeably.

As used herein, the term “agrochemically acceptable salt” means a salt which is acceptable for use in agrochemical or horticultural use. The salts referred to herein are agrochemically acceptable salts.

As used herein, the term “fungicide” denotes a compound which controls or modifies the growth of fungus.

As used herein, the term “fungicidal” refers to the ability of a substance to control or modify the growth of fungus or its spores.

As used herein, the term “fungicidally effective amount” indicates the quantity of such a compound or combination of such compounds which is capable of controlling or modifying the growth of the fungus. The terms “effective amount” or “agriculturally acceptable effective amount”, refer to an amount of an active ingredient, such as in the disclosed combination(s), which has an adverse effect on a fungus, treats or prevents a fungal disease in a plant, and is not significantly toxic to the plant being treated. The adverse effect can include killing of the fungus (fungicidal), preventing growth of the fungus, blocking of biosynthetic pathway(s), or a combination thereof.

As used herein, the term “control” or “disease control” refers to the treatment and/or prevention of a disease, and specifically, a fungal disease. Controlling effects include any and all deviations from the natural development of the disease, for example: killing of the fungal agent, retardation of disease development, and decrease in amount or degree of the fungal disease.

As used herein, the term “plant(s)” or “crop(s)” refers to the physical parts of a plant, including for example, seeds, seedlings, saplings, roots, tubers, stems, stalks, foliage, and fruits. This term also encompasses plant crops such as fruits. The term “plant” is limited to a living plant organism which expresses a set of characteristics determined by its single, genetic makeup or genotype, which can be duplicated through asexual reproduction, but which cannot otherwise be “made” or “manufactured.

The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

The term “locus” as used herein shall denote habitat, soil, area, material or environment in which a pest is growing or may grow, where plant propagation materials of the plants are sown, and/or where the plant propagation materials of the plants will be placed into soil, the vicinity of a desired crop in which the control of the spread of phytopathogenic fungi is desired. The locus includes the vicinity of desired crop plants wherein the phytopathogenic fungi infection has either emerged or is most likely to emerge or is yet to emerge.

As used herein, the term “plant propagation material” is understood to refer to all of the generative parts of a plant, such as seeds, vegetative material such as cuttings or tubers, roots, fruits, tubers, bulbs, rhizomes, and other parts of plants, germinated plants, and/or young plants which are to be transplanted after germination or after emergence from the soil. These young plants may be protected prior to transplantation by a total or partial immersion treatment/system.

As used herein, the term “seed” embraces seeds and plant propagules of all kinds including but not limited to true seeds, seed pieces, suckers, corms, bulbs, fruit, tubers, grains, cuttings, cut shoots and the like.

As used herein, the term “increased yield” of an agricultural plant means that the yield of a product of the respective plant is increased by a measurable amount over the yield of the same product of the plant produced under the same conditions, but without the application of the compositions described herein. The composition also increases the vigour/yield of the plant.

As used herein, the term “g ai/L” as used herein denotes the concentration of the respective active ingredient in “grams” present “per litre” of the composition.

As used herein, the term “g ai/h” as used herein denotes the amount of the respective active ingredient in “grams” applied “per hectare” of the crop field or of the tree plantation.

As used herein, the term “effective amount” refers to an amount of the agrochemical composition or of the mixture which is sufficient for controlling harmful fungi on crop plants and does not cause any significant damage to the treated crop plants.

As used herein, the phrase “agriculturally acceptable carrier” means carriers which are known and accepted in the art for the formation of compositions for agricultural or horticultural use.

According to the present disclosure, it is preferred that the crop yield be increased by at least 0.5%, preferred at least 2%, more preferred at least 5%, upon application of the combinations/compositions described herein.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other ingredients or excipients not specifically recited therein.

The present inventors have unexpectedly found that the application of the fungicidal combination comprising a succinate dehydrogenase inhibitor fungicide, and a demethylation inhibitor fungicide effectively controls fungal diseases in wheat. Amongst fungal diseases in wheat crop, tan spot and yellow rust are high pressure diseases causing maximum damage in crop quality and yield. Further, the addition of a multi-site fungicide to the fungicidal combination effectively controls fungal diseases in wheat, particularly tan spot, leaf spot, and yellow rust.

In an embodiment, the present invention provides a fungicidal combination for controlling fungal infestation in wheat crop, the combination comprising;
(i) a succinate dehydrogenase inhibitor fungicide, and
(ii) a demethylation inhibitor fungicide.

In another embodiment, the present invention provides a fungicidal combination for controlling fungal infestation in wheat crop, the combination comprising;
(i) a succinate dehydrogenase inhibitor fungicide,
(ii) a demethylation inhibitor fungicide, and
(iii) a multi-site fungicide.

In an embodiment, the succinate dehydrogenase inhibitor fungicide is selected from the group comprising phenyl-benzamides, phenyl-oxo-ethyl thiophene amides, pyridinyl-ethyl benzamides, phenyl-cyclobutyl pyridine amides, furan-carboxamides, oxathiin carboxamides, thiazole carboxamides, pyrazole-4-carboxamides, N-cyclopropyl-N-benzyl-pyrazole carboxamides, N-methoxy-(phenylethyl)-pyrazole carboxamides, pyridine carboxamides and pyrazine carboxamides.

In an embodiment, the phenyl-benzamide is selected from the group comprising benodanil, flutolanil or mepronil.

In an embodiment, the pyridinyl-ethyl benzamide is fluopyram.

In an embodiment, the oxathiin carboxamide is carboxin and oxycarboxin.

In an embodiment, the pyridine carboxamide is boscalid.

In an embodiment, the pyrazole-4-carboxamide is selected from the group comprising benzovindiflupyr, bixafen, fluindapyr, fluxapyroxad, furametpyr, inpyrfluxam, isopyrazam, penflufen, penthiopyrad and sedaxane.

In an embodiment, the succinate dehydrogenase inhibitor fungicide is bixafen.

In an embodiment, the succinate dehydrogenase inhibitor fungicide is benzovindiflupyr.

In an embodiment, the succinate dehydrogenase inhibitor fungicide is fluindapyr.

In an embodiment, the succinate dehydrogenase inhibitor fungicide is inpyrfluxam.

In a preferred embodiment, the succinate dehydrogenase inhibitor fungicide is fluxapyroxad.

In an embodiment, the demethylation inhibitor fungicide is selected from one or more of azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, mefentrifluconazole, metconazole, myclobutanil, penconazole, propiconazole, simeconazole, tebuconazole, tetraconazole, triadimefon, triadimenol, triticonazole, and prothioconazole.

In an embodiment, the demethylation inhibitor fungicide is tebuconazole.

In an embodiment, the demethylation inhibitor fungicide is cyproconazole.

In an embodiment, the demethylation inhibitor fungicide is mefentrifluconazole.

In a preferred embodiment, the demethylation inhibitor fungicide is ipconazole.

In an embodiment, the demethylation inhibitor fungicide is thiophanate or thiophanate-methyl.

In an embodiment, the demethylation inhibitor fungicide is carbendazim.

In a preferred embodiment, the demethylation inhibitor fungicide is prothioconazole.

In an embodiment, the multisite fungicide is selected from the group consisting of copper (different salts), sulphur, ferbam, mancozeb, maneb, metiram, propineb, thiram, zinc thiazole, zineb, ziram, captan, captafol, folpet, chlorothalonil, dichlofluanid, tolylfluanid, guazatine, iminoctadine, anilazine, dithianon, chinomethionat/quinomethionate, fluoroimide, and methasulfocarb.

In an embodiment, the multisite fungicide is chlorothalonil.

In an embodiment, the multisite fungicide is sulphur.

In an embodiment, the multisite fungicide is copper, a copper salt, copper sulphate, tribasic copper sulphate and the like.

In a preferred embodiment, the multisite fungicide is mancozeb.

In an embodiment, the present disclosure relates to a fungicidal combination for controlling fungal infestation in wheat crop, the combination comprising fluxapyroxad and prothioconazole.

In another embodiment, the present invention provides a fungicidal combination for controlling fungal infestation in wheat crop, the combination comprising;
(i) a succinate dehydrogenase inhibitor fungicide,
(ii) a demethylation inhibitor fungicide, and/or
(iii) a Quinone Outside Inhibitor fungicide (QoI).

In another embodiment, the present invention provides a fungicidal combination for controlling fungal infestation in wheat crop, the combination comprising;
(i) a succinate dehydrogenase inhibitor fungicide,
(ii) a demethylation inhibitor fungicide,
(iii) a multi-site fungicide, and/or
(iv) a Quinone Outside Inhibitor fungicide (QoI).

In an embodiment, the present invention provides a Quinone Outside Inhibitor fungicide (QoI) selected from the group comprising azoxystrobin coumoxystrobin enoxastrobin flufenoxystrobin picoxystrobin pyraoxystrobin, mandestrobin, pyraclostrobin, pyrametostrobin, triclopyricarb, kresoxim-methyl, trifloxystrobin, dimoxystrobin fenaminstrobin metominostrobin orysastrobin, famoxadone, fluoxastrobin, fenamidone, pyribencarb and metyltetraprole.

In another preferred embodiment, the present disclosure relates to a fungicidal combination comprising fluxapyroxad, prothioconazole and a multi-site fungicide.

In an embodiment, the present disclosure relates to a fungicidal combination for controlling fungal infestation in wheat crop, the combination comprising fluxapyroxad, prothioconazole and sulphur.

In an embodiment, the present disclosure relates to a fungicidal combination for controlling fungal infestation in wheat crop, the combination comprising fluxapyroxad, prothioconazole and captan.

In an embodiment, the present disclosure relates to a fungicidal combination for controlling fungal infestation in wheat crop, the combination comprising fluxapyroxad, prothioconazole and chlorothalonil.

In an embodiment, the present disclosure relates to a fungicidal combination for controlling fungal infestation in wheat crop, the combination comprising fluxapyroxad, prothioconazole and copper or its salts.

In an embodiment, the present disclosure relates to a fungicidal combination for controlling fungal infestation in wheat crop, the combination comprising fluxapyroxad, prothioconazole and tribasic copper sulphate.

In an embodiment, the present disclosure relates to a fungicidal combination for controlling fungal infestation in wheat crop, the combination comprising fluxapyroxad, prothioconazole and copper oxychloride.

In a preferred embodiment, the present disclosure relates to a fungicidal combination for controlling fungal infestation in wheat crop, the combination comprising fluxapyroxad, prothioconazole and mancozeb.

In a preferred embodiment, the present invention provides a fungicidal combination for controlling fungal infestation in wheat crop, the combination comprising one or more fungicides selected from the group comprising fluxapyroxad, prothioconazole and mancozeb.

In all the fungicidal combinations embodying the principle of the instant disclosure, succinate dehydrogenase inhibitor fungicide, a demethylation inhibitor fungicide, and a multi-site fungicide include their derivatives such as salts, esters, ethers, solvates, hydrates and polymorphs.

In an embodiment, the present invention provides a fungicidal combination for controlling fungal infestation in wheat crop, the combination comprising;
(i) a succinate dehydrogenase inhibitor fungicide, and
(ii) a demethylation inhibitor fungicide, wherein the weight ratio of the succinate dehydrogenase inhibitor fungicide and the demethylation inhibitor fungicide is ranging from 1:50 to 50:1.

In an embodiment, the present invention provides a fungicidal combination for controlling fungal infestation in wheat crop, the combination comprising;
(i) a succinate dehydrogenase inhibitor fungicide, and
(ii) a demethylation inhibitor fungicide, wherein the weight ratio of the succinate dehydrogenase inhibitor fungicide and the demethylation inhibitor fungicide is ranging from 1:20 to 20:1.

In an embodiment, the present invention provides a fungicidal combination for controlling fungal infestation in wheat crop, the combination comprising;
(i) a succinate dehydrogenase inhibitor fungicide, and
(ii) a demethylation inhibitor fungicide,
   wherein the weight ratio of the succinate dehydrogenase inhibitor fungicide and the demethylation inhibitor fungicide is ranging from 1:10 to 10:1.

In an embodiment, the present invention provides a fungicidal combination for controlling fungal infestation in wheat crop, the combination comprising fluxapyroxad and prothioconazole in a ratio ranging from 1:50 to 50:1.

In an embodiment, the present invention provides a fungicidal combination for controlling fungal infestation in wheat crop, the combination comprising fluxapyroxad and prothioconazole in a ratio ranging from 1:20 to 20:1.

In an embodiment, the present invention provides a fungicidal combination for controlling fungal infestation in wheat crop, the combination comprising fluxapyroxad and prothioconazole in a ratio ranging from 1:10 to 10:1.

In an embodiment, the present invention provides a fungicidal combination for controlling fungal infestation in wheat crop, the combination comprising fluxapyroxad and prothioconazole in a ratio ranging from 1:5.

In an embodiment, the present invention provides a fungicidal combination for controlling fungal infestation in wheat crop, the combination comprising fluxapyroxad and prothioconazole in a ratio ranging from 1:2.

In an embodiment, the present invention provides a fungicidal combination for controlling fungal infestation in wheat crop comprising fluxapyroxad and prothioconazole in a ratio ranging from 1:1.5.

In an embodiment, the present disclosure provides a fungicidal combination for controlling fungal infestation in wheat crop comprising;
(i) a succinate dehydrogenase inhibitor fungicide,
(ii) a demethylation inhibitor fungicide, and
(iii) a multi-site fungicide;
   wherein the weight ratio of the succinate dehydrogenase inhibitor fungicide, demethylation inhibitor fungicide and the multi-site fungicide is in a ratio ranging from 1:1:100 to 100:3:1.

In an embodiment, the present disclosure relates to a fungicidal combination for controlling fungal infestation in wheat crop comprising;
(i) a succinate dehydrogenase inhibitor fungicide,
(ii) a demethylation inhibitor fungicide, and
(iii) a multi-site fungicide;
   wherein the weight ratio of the succinate dehydrogenase inhibitor fungicide, demethylation inhibitor fungicide and the multi-site fungicide is in a ratio ranging from 1:1:75 to 75:3:1.

In an embodiment, the present disclosure relates to a fungicidal combination for controlling fungal infestation in wheat crop comprising;
(i) a succinate dehydrogenase inhibitor fungicide,
(ii) a demethylation inhibitor fungicide, and
(iii) a multi-site fungicide;
   wherein the weight ratio of the succinate dehydrogenase inhibitor fungicide, demethylation inhibitor fungicide and the multi-site fungicide is in a ratio ranging from 1:1:50 to 50:3:1.

In an embodiment, the present disclosure relates to a fungicidal combination for controlling fungal infestation in wheat crop comprising;
(i) a succinate dehydrogenase inhibitor fungicide,
(ii) a demethylation inhibitor fungicide, and
(iii) a multi-site fungicide;
   wherein the weight ratio of the succinate dehydrogenase inhibitor fungicide, demethylation inhibitor fungicide and the multi-site fungicide is in a ratio ranging from 1:1:25 to 25:3:1.

In an embodiment, the present disclosure relates to a fungicidal combination for controlling fungal infestation in wheat crop comprising;
(iv) a succinate dehydrogenase inhibitor fungicide,
(v) a demethylation inhibitor fungicide, and
(vi) a multi-site fungicide;
   wherein the weight ratio of the succinate dehydrogenase inhibitor fungicide, demethylation inhibitor fungicide and the multi-site fungicide is in a ratio ranging from 1:1:10 to 10:3:1.

According to an embodiment, the present invention provides a fungicidal combination comprising fluxapyroxad, prothioconazole and mancozeb in a ratio ranging from 1:1:25 to 25:3:1 for controlling fungal infestation in wheat crop.

According to an embodiment, the present invention provides a fungicidal combination comprising fluxapyroxad, prothioconazole and mancozeb in a ratio ranging from 1:1:10 to 10:3:1 for controlling fungal infestation in wheat crop.

According to an embodiment, the present invention provides a fungicidal combination comprising fluxapyroxad, prothioconazole and mancozeb in a ratio of 1:1:20.

According to an embodiment, the present invention provides a fungicidal combination comprising fluxapyroxad, prothioconazole and mancozeb in a ratio of 1:1.5:18.

In an embodiment, the combinations of the present disclosure comprise at least one additional fungicide.

According to an embodiment, the present invention provides a combination of fluxapyroxad, prothioconazole, mancozeb and an additional fungicide fungal infestation in wheat crop.

Non-limiting examples of the additional fungicide include nucleic acid synthesis inhibitor, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defence inducers, fungicides with unknown modes of action, fungicide with no classification, or biologicals with multiple mode of action.

In an aspect, the present disclosure provides a fungicidal composition for controlling fungal infestation in wheat crop, said composition comprising;
(i) a succinate dehydrogenase inhibitor fungicide, and
(ii) a demethylation inhibitor fungicide.

In another embodiment, the present disclosure provides a fungicidal composition for controlling fungal infestation in wheat crop, the composition comprising;
(i) a succinate dehydrogenase inhibitor fungicide,
(ii) a demethylation inhibitor fungicide, and
(iii) a multi-site fungicide.

In an embodiment, the present disclosure relates to a fungicide composition for controlling fungal infestation in wheat crop, the composition comprising;
(i) a succinate dehydrogenase inhibitor fungicide,
(ii) a demethylation inhibitor fungicide,
(iii) a multi-site fungicide, and
(iv) one or more agrochemically acceptable excipients.

In an embodiment, the present disclosure relates to a fungicidal composition comprising fluxapyroxad, prothioconazole, mancozeb and one or more agrochemically acceptable excipients for controlling fungal infestation in wheat crop.

In an embodiment, the present disclosure provides a fungicidal composition for controlling phytopathogenic fungi comprising a succinate dehydrogenase inhibitor fungicide in a concentration ranging from about 1% to 99%, a demethylation inhibitor fungicide in a concentration ranging from about 1% to 99%, a multisite fungicide in a concentration ranging from about 1% to 99% optionally one or more agrochemically acceptable excipients in a concentration from about 1% to 50%, by weight of the total composition.

In an embodiment, the present disclosure provides a fungicidal composition for controlling phytopathogenic fungi comprising a succinate dehydrogenase inhibitor fungicide in a concentration ranging from 0.1% to 20%, a demethylation inhibitor fungicide in a concentration ranging from 1% to 20%, a multisite fungicide in a concentration ranging from 40% to 80% and one or more agrochemically acceptable excipients in a concentration ranging from 0.1% to 30%, by weight of the total composition.

In an embodiment, the present disclosure provides a fungicidal composition for controlling phytopathogenic fungi comprising a succinate dehydrogenase inhibitor fungicide in a concentration ranging from 0.1% to 20% w/v, a demethylation inhibitor fungicide in a concentration ranging from 1% to 20% w/v, a multisite fungicide in a concentration ranging from 40% to 80% w/v and one or more agrochemically acceptable excipients in a concentration ranging from 0.1% to 30% w/v, of the total composition.

In an embodiment, the present disclosure provides a fungicidal composition for controlling phytopathogenic fungi comprising a succinate dehydrogenase inhibitor fungicide in a concentration ranging from 0.1% to 20% w/w, a demethylation inhibitor fungicide in a concentration ranging from 1% to 20% w/w, a multisite fungicide in a concentration ranging from 40% to 80% w/w and one or more agrochemically acceptable excipients in a concentration ranging from 0.1% to 30% w/w, of the total composition.

In an embodiment, the present disclosure provides a fungicidal composition for controlling phytopathogenic fungi comprising fluxapyroxad in a concentration ranging from 0.1% to prothioconazole in a concentration ranging from 1% to 20%, mancozeb in a concentration ranging from 40% to 80% and one or more agrochemically acceptable excipients in a concentration ranging from 0.1% to 30%, by weight of the total composition.

In an embodiment, the present disclosure provides a fungicidal composition for controlling phytopathogenic fungi comprising fluxapyroxad in a concentration ranging from 0.1% to 20% w/v, prothioconazole in a concentration ranging from 1% to 20% w/v, mancozeb in a concentration ranging from 40% to 80% w/v and one or more agrochemically acceptable excipients in a concentration ranging from 0.1% to 30% w/v, by weight of the total composition.

In an embodiment, the present disclosure provides a fungicidal composition for controlling phytopathogenic fungi comprising fluxapyroxad in a concentration ranging from 0.1% to 20% w/w, prothioconazole in a concentration ranging from 1% to 20% w/w, mancozeb in a concentration ranging from 40% to 80% w/w and one or more agrochemically acceptable excipients in a concentration ranging from 0.1% to 30% w/w, by weight of the total composition.

In an embodiment, the amount of succinate dehydrogenase inhibitor fungicide in the combinations or compositions of the present invention may range from about 50 to 75 g ai/ha.

In an embodiment, the amount of demethylation inhibitor fungicide in the combinations or compositions of the present invention may range from about 85 to 125 g ai/ha.

In an embodiment, the amount of multi-site fungicides in the combinations or compositions of the present invention may range from about 500 to 1500 g ai/ha.

In an embodiment, the amount of fluxapyroxad in the combinations or compositions of the present invention may range from about 50 to 75 g ai/ha.

In an embodiment, the amount of prothioconazole in the combinations or compositions of the present invention may range from about 85 to 125 g ai/ha.

In an embodiment, the amount of mancozeb in the combinations or compositions of the present invention may range from about 500 to 1500 g ai/ha.

In an embodiment, the present compositions may be in any agriculturally suitable form for storage and application to the ground. The compositions of the present invention may typically be produced by mixing the actives in the composition with an inert carrier, and adding surfactants and other adjuvants and carriers as needed and formulated into solid, or liquid formulations, including but not limited to a soluble concentrate (SL), a dispersible concentrate, an emulsifiable concentrate (EC), a suspension (SC, OD, FS), an emulsion (EW), a slurry of particles in an aqueous medium (e.g. water), a paste, a water-dispersible or water-soluble powder (WP), a pastille, a water-dispersible or water-soluble granule (WG), a dry granule (GR), a gel formulation and a dustable powder or other known formulation types. The composition may also be used for treatment of a plant propagation material such as seeds etc.

In another embodiment, the compositions of the present invention can further comprise at least one additional agrochemical/pesticide. Examples of pesticides include, but are not limited to, herbicides, fungicides, miticides, larvicides, avicides, insecticides, nematicides and rodenticides.

In an embodiment, the agrochemically acceptable excipients are selected from the group consisting of surfactants, antifreeze agent, wetting agent, antifoaming agent, thickening agent, preservative, colorant, filler, and combinations thereof.

In an embodiment the formulation includes surfactants for example a non-ionic surfactant or an anionic surfactant.

In an embodiment of the present invention, non-ionic surfactant is selected from the group of polyalkyleneoxide siloxanes, ethoxylated derivatives of fatty alcohols, alkyl glucosides, alkyl phenols, polyalkylene glycol ethers and condensation products of alkyl phenols, amines, fatty acids, fatty esters, mono-, di-, or triglycerides, various block copolymeric surfactants derived from alkylene oxides such as ethylene oxide (EO)/propylene oxide (PO), aliphatic amines or fatty acids with ethylene oxides and/or propylene oxides such as the ethoxylated alkyl phenols or ethoxylated aryl or polyaryl phenols, carboxylic esters solubilized with a polyol or polyvinyl alcohol/polyvinyl acetate copolymers, polyvinyl alcohol, polyvinyl pyrrolidinones and acrylic acid graft copolymers and mixtures, reaction products, and/or copolymers thereof.

In a preferred embodiment, non-ionic surfactant is selected from the group comprising various block copolymeric surfactants derived from alkylene oxides such as ethylene oxide/propylene oxide, aliphatic amines or fatty acids with ethylene oxides and/or propylene oxides such as the ethoxylated alkyl phenols or ethoxylated aryl or polyaryl phenols, their mixtures, reaction products, and/or copolymers thereof.

In an embodiment, the composition comprises from about 0.1% to about 50% w/w and preferably from about 1% to about 40% w/w non-ionic surfactant of the total weight of the composition.

In an embodiment, anionic surfactant is selected from the group comprising alkyl and aryl sulfates and sulfonates, including sodium alky sulfates, sodium mono- and di-alkyl naphthalene sulfonates, sodium alpha-olefin sulfonate, lignin and its derivatives (such as lignosulfonate salts, sodium lignosulfonate), sodium alkane sulfonates, polyoxyalkyene alkylether sulfate, polyoxyalkylene alkylaiyl ether sulfates, polyoxy-alkylene styrylphenyl ether sulfate, mono- and di-alkylbenzene sulfonates, alkylnaphthalene sulfonate, alkylnaphthalene sulfonate formaldehyde condensate, alkyl diphenylether sulfonates, olefine sulfonates, alkylphosphates, polyoxyalkylene alkyl phosphates, polyoxyalkylene phenylether phosphate, polyoxyalkylphenol phosphates, poly-carboxylates, fatty acids and salts thereof, alkyl glycinates, sulfonated methyl esters, sulfonated fatty acids, sulfosuccinates and their derivatives, acyl glutamates, acyl sarcosinates, alkyl sulfoacetates, acylated peptides, alkyl ether carboxylates, acyl lactylates, anionic fluorosurfactants, amid ether sulfates, N-methyl fatty acid taurides, mixtures thereof and the like, including sodium, potassium, ammonium and amine salts, etc. or mixtures thereof.

In a preferred embodiment, anionic surfactant is selected from the group comprising alkyl and aryl sulfates and sulfonates, including sodium alkyl sulfates, sodium mono- and di-alkyl naphthalene sulfonates, lignin, and its derivatives (such as lignosulfonate salts), polyoxyalkyene alkylether sulfate, alkylnaphthalene sulfonate, alkylnaphthalene sulfonate formaldehyde condensate.

In an embodiment, the composition comprising from about 0.1% to about 50% w/w and preferably from about 1% to about 40% w/w of anionic surfactant of the total weight of the composition.

Suitable antifreeze agents that can be added to the agrochemical composition are liquid polyols, for example ethylene glycol, propylene glycol or glycerol.

Examples of wetting agents that can be added to the agrochemical composition of the present invention include, but are not limited to: polyarylalkoxylated phosphate esters and their potassium salts. Other suitable wetting agents include sodium dioctylsulfosuccinates and ethoxylated alcohols.

Antifoaming or defoamers are employed to stop any unwanted foam generated while manufacturing highly concentrated liquid biocide dispersion composition. The preferred antifoaming agent is selected from the group of silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination.

Examples of thickening agents based on anionic heteropolysaccharides from the xanthan gum group.

Suitable colorants are, pigments, which are sparingly soluble in water, and dyes, which are water-soluble. Examples are inorganic coloring agents including iron oxide, titanium oxide, iron hexacyanoferrate and organic coloring agents including alizarin, azo and phthalocyanin coloring agents.

Suitable preservatives are for example 1,2-benzisothiazolin-3-one and/or 2-Methyl-2H-isothiazol-3-one or sodium benzoate or benzoic acid.

The fungicidal combinations and compositions of the present disclosure can be in any conventional agriculturally useful form, for example, in the form of a ready-to-use formulation, or in the form of a tank mix.

In an embodiment, the fungicidal actives may be formulated as a premix product or a ready-to-use product.

In an embodiment, the fungicidal actives may be tank-mixed at the time of application.

In an embodiment, the method comprises applying the present combinations or compositions simultaneously, that is jointly or separately, or in succession.

In another embodiment, the constituents of the combination of the present invention may be tank mixed and applied or sprayed at the locus of the infection or may be alternatively mixed with surfactants and/or any other agrochemically suitable excipients and then applied.

In yet another embodiment, the constituents of the combination of the present invention may be applied in such quick succession in any order to form the desired mix at the locus of application.

In an embodiment, the constituents of the composition of the present invention may be used for foliar application, ground or applications to plant propagation materials.

The application according to the disclosure, on the plants and plant parts with the active compound or its compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching) and drip irrigating. It is furthermore possible to apply the active compound in combination with other active(s) by the ultra-low volume method, or to inject the active compound combination into the soil by suitable machine or articles.

Typically, the present combinations/compositions are significantly effective in controlling a variety of undesirable fungi that infect useful wheat crop. The present combinations/compositions are effective against a variety of Ascomycete fungi, including the representative fungi species for example:

In an embodiment the present combinations/compositions are effective for controlling fungal diseases in wheat crop comprising rust (Puccinia striiformis, P. graminis, P. recondita), yellow spot (Pyrenophora tritici-repentis), powdery mildew (Erysiphe graminis), Fusarium head blight (Fusarium graminearum, F. avenacerum, F. culmorum, Microdochium nivale), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum) and septoria.

In preferred embodiment, the present combinations/compositions are effective for controlling rust (Puccinia striiformis, P. graminis, P. recondita) and yellow spot (Pyrenophora tritici-repentis).

The combinations and compositions of the present invention are used to control phytopathogenic fungi, particularly wheat disease namely tan spot caused by Pyrenophora tritici-repentis (Ptr). Puccinia striiformis f. sp. tritici (Pst).

The combinations and compositions of the present invention are used to control phytopathogenic fungi, particularly Septoria sp.

The combinations and compositions of the present invention are used to control phytopathogenic fungi, particularly Septoria tritici.

The combinations and compositions of the present invention are used to control phytopathogenic fungi in wheat crop, particularly yellow rust Puccinia striiformis f. sp. tritici (Pst).

The combinations and compositions of the present invention are used to control Pyrenophora tritici-repentis,

In an embodiment, the present disclosure relates to the use of a fungicidal combination for controlling fungal infestation in wheat crop, the combination comprising;
(i) a succinate dehydrogenase inhibitor fungicide, and
(ii) a demethylation inhibitor fungicide.

In a preferred embodiment, the present disclosure relates to the use of a fungicidal combination comprising fluxapyroxad and prothioconazole for controlling fungal infestation in wheat crop.

In an embodiment, the present disclosure relates to the use of a fungicidal combination for controlling fungal infestation in wheat crop, the combination comprising;
(i) a succinate dehydrogenase inhibitor fungicide,
(ii) a demethylation inhibitor fungicide, and
(iii) a multi-site fungicide.

In a preferred embodiment, the present disclosure relates to the use of a fungicide combination comprising fluxapyroxad, prothioconazole and mancozeb for controlling fungal infestation in wheat crop.

In another embodiment, the present invention provides use of a fungicidal combination for controlling fungal infestation in wheat crop, the combination comprising;
(i) a succinate dehydrogenase inhibitor fungicide,
(ii) a demethylation inhibitor fungicide, and/or
(iii) a Quinone Outside Inhibitor fungicide (QoI).

In another embodiment, the present invention provides use of a fungicidal combination for controlling fungal infestation in wheat crop, the combination comprising;
(iv) a succinate dehydrogenase inhibitor fungicide,
(v) a demethylation inhibitor fungicide,
(vi) a multi-site fungicide, and/or
(vii) a Quinone Outside Inhibitor fungicide (QoI).

In an embodiment, the present invention provides a Quinone Outside Inhibitor fungicide (QoI) selected from the group comprising azoxystrobin coumoxystrobin enoxastrobin flufenoxystrobin picoxystrobin pyraoxystrobin, mandestrobin, pyraclostrobin, pyrametostrobin, triclopyricarb, kresoxim-methyl, trifloxystrobin, dimoxystrobin fenaminstrobin metominostrobin orysastrobin, famoxadone, fluoxastrobin, fenamidone, pyribencarb and metyltetraprole.

In an embodiment, the present disclosure relates to the use of a fungicide composition for controlling fungal infestation in wheat caused by Puccinia striiformis or Pyrenophora tritici-repentis, the composition comprising;
(i) a succinate dehydrogenase inhibitor fungicide, and
(ii) a demethylation inhibitor fungicide.

In a preferred embodiment, the present disclosure relates to the use of a fungicide composition comprising fluxapyroxad and prothioconazole for controlling fungal infestation in wheat caused by Puccinia striiformis or Pyrenophora tritici-repentis,

In a preferred embodiment, the present disclosure relates to the use of a fungicide composition comprising fluxapyroxad and prothioconazole for controlling fungal infestation in wheat caused by Septoria tritici.

In an embodiment, the present disclosure relates to the use of a fungicidal composition for controlling fungal infestation in wheat crop, the composition comprising;
(i) a succinate dehydrogenase inhibitor fungicide,
(ii) a demethylation inhibitor fungicide,
(iii) a multi-site fungicide, and
(iv) agrochemically acceptable excipients.

In a preferred embodiment, the present disclosure relates to the use of a fungicidal composition comprising fluxapyroxad, prothioconazole and mancozeb for controlling fungal infestation in wheat caused by Puccinia striiformis.

In a preferred embodiment, the present disclosure relates to the use of a fungicidal composition comprising fluxapyroxad, prothioconazole and mancozeb for controlling fungal infestation in wheat caused by Pyrenophora tritici-repentis.

In a preferred embodiment, the present disclosure relates to the use of a fungicidal composition comprising fluxapyroxad, prothioconazole and mancozeb for controlling fungal infestation in wheat caused by Septoria tritici.

In an embodiment, the present disclosure relates to a method of controlling fungal infestation in wheat crop, the method comprising applying to a plant or to a locus of a plant or a plant propagation thereof, a fungicidal combination comprising;
(i) a succinate dehydrogenase inhibitor fungicide in an amount ranging from 10 to 300 g ai/ha, and
(ii) a demethylation inhibitor fungicide in an amount ranging from 10 to 500 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) a succinate dehydrogenase inhibitor fungicide in an amount ranging from 20 to 150 g ai/ha, and
(ii) a demethylation inhibitor fungicide in an amount ranging from 20 to 300 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) a succinate dehydrogenase inhibitor fungicide in an amount ranging from 30 to 100 g ai/ha, and
(ii) a demethylation inhibitor fungicide in an amount ranging from 50 to 150 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) fluxapyroxad in an amount ranging from 10 to 300 g ai/ha, and
(ii) prothioconazole in an amount ranging from 10 to 500 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) fluxapyroxad in an amount ranging from 20 to 150 g ai/ha, and
(ii) prothioconazole in an amount ranging from 20 to 300 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) fluxapyroxad in an amount ranging from 30 to 100 g ai/ha, and
(ii) prothioconazole in an amount ranging from 50 to 150 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) fluxapyroxad in an amount ranging from 10 to 300 g ai/ha, and
(ii) prothioconazole in an amount ranging from 100 to 500 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) fluxapyroxad in an amount ranging from 20 to 150 g ai/ha, and
(ii) prothioconazole in an amount ranging from 20 to 300 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) fluxapyroxad in an amount ranging from 30 to 100 g ai/ha, and
(ii) prothioconazole in an amount ranging from 50 to 150 g ai/ha.

In an embodiment, the present disclosure relates to a method of controlling Septoria sp. infestation in wheat crop, the method comprising applying to a plant or to a locus of a plant or a plant propagation thereof, a fungicidal combination comprising;
(i) fluxapyroxad in an amount ranging from 10 to 300 g ai/ha, and
(ii) prothioconazole in an amount ranging from 10 to 500 g ai/ha.

In an embodiment, the present disclosure relates to a method of controlling Septoria sp. infestation in wheat crop, the method comprising applying to a plant or to a locus of a plant or a plant propagation thereof, a fungicidal combination comprising;
(i) fluxapyroxad in an amount ranging from 20 to 150 g ai/ha, and
(ii) prothioconazole in an amount ranging from 20 to 300 g ai/ha.

In an embodiment, the present disclosure relates to a method of controlling Septoria sp. infestation in wheat crop, the method comprising applying to a plant or to a locus of a plant or a plant propagation thereof, a fungicidal combination comprising;
(i) fluxapyroxad in an amount ranging from 30 to 100 g ai/ha, and
(ii) prothioconazole in an amount ranging from 50 to 150 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount ranging from 10 to 300 g ai/ha, and
(ii) prothioconazole in an amount ranging from 10 to 500 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount ranging from 20 to 150 g ai/ha, and
(ii) prothioconazole in an amount ranging from 20 to 300 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount ranging from 30 to 100 g ai/ha, and
(ii) prothioconazole in an amount ranging from 50 to 150 g ai/ha.

In an embodiment, the present disclosure relates to a method of controlling Puccinia striformis infestation in wheat crop, the method comprising applying to a plant or to a locus of a plant or a plant propagation thereof, a fungicidal combination comprising;
(i) fluxapyroxad in an amount ranging from 10 to 300 g ai/ha, and
(ii) prothioconazole in an amount ranging from 100 to 500 g ai/ha.

In an embodiment, the present disclosure relates to a method of controlling Puccinia striformis infestation in wheat crop, the method comprising applying to a plant or to a locus of a plant or a plant propagation thereof, a fungicidal combination comprising;
(i) fluxapyroxad in an amount ranging from 20 to 150 g ai/ha, and
(ii) prothioconazole in an amount ranging from 20 to 300 g ai/ha.

In an embodiment, the present disclosure relates to a method of controlling Puccinia striformis infestation in wheat crop, the method comprising applying to a plant or to a locus of a plant or a plant propagation thereof, a fungicidal combination comprising;
(i) fluxapyroxad in an amount ranging from 30 to 100 g ai/ha, and
(ii) prothioconazole in an amount ranging from 50 to 150 g ai/ha

In an embodiment, the present disclosure relates to a method of controlling fungal infestation in wheat crop, the method comprising applying to a plant or to a locus of a plant or a plant propagation thereof, a fungicidal combination comprising;
(i) a succinate dehydrogenase inhibitor fungicide,
(ii) a demethylation inhibitor fungicide, and
(iii) a multi-site fungicide.

In an embodiment, the present disclosure relates to a method of controlling fungal infestation in wheat crop, the method comprising applying to a plant or to a locus of a plant or a plant propagation thereof, a fungicidal combination comprising;
(i) a succinate dehydrogenase inhibitor fungicide in an amount ranging from 10 to 300 g ai/ha,
(ii) a demethylation inhibitor fungicide in an amount ranging from 20 to 250 g ai/ha, and
(iii) a multi-site fungicide in an amount ranging from 500 to 2000 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) a succinate dehydrogenase inhibitor fungicide in an amount ranging from 50 to 150 g ai/ha,
(ii) a demethylation inhibitor fungicide in an amount ranging from 50 to 200 g ai/ha, and
(iii) a multi-site fungicide in an amount ranging from 500 to 1500 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) a succinate dehydrogenase inhibitor fungicide in an amount ranging from 50 to 75 g ai/ha,
(ii) a demethylation inhibitor fungicide in an amount ranging from 85 to 125 g ai/ha, and
(iii) a multi-site fungicide in an amount ranging from 800 to 1200 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) a succinate dehydrogenase inhibitor fungicide in an amount ranging from 10 to 300 g ai/ha,
(ii) a demethylation inhibitor fungicide in an amount ranging from 20 to 250 g ai/ha, and
(iii) a multi-site fungicide in an amount ranging from 500 to 2000 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) a succinate dehydrogenase inhibitor fungicide in an amount ranging from 50 to 150 g ai/ha,
(ii) a demethylation inhibitor fungicide in an amount ranging from 50 to 200 g ai/ha, and
(iii) a multi-site fungicide in an amount ranging from 500 to 1500 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) a succinate dehydrogenase inhibitor fungicide in an amount ranging from 50 to 75 g ai/ha,
(ii) a demethylation inhibitor fungicide in an amount ranging from 85 to 125 g ai/ha, and
(iii) a multi-site fungicide in an amount ranging from 800 to 1200 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) a succinate dehydrogenase inhibitor fungicide in an amount ranging from 10 to 300 g ai/ha,
(ii) a demethylation inhibitor fungicide in an amount ranging from 20 to 250 g ai/ha, and
(iii) a multi-site fungicide in an amount ranging from 500 to 2000 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) a succinate dehydrogenase inhibitor fungicide in an amount ranging from 50 to 150 g ai/ha,
(ii) a demethylation inhibitor fungicide in an amount ranging from 50 to 200 g ai/ha, and
(iii) a multi-site fungicide in an amount ranging from 500 to 1500 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) a succinate dehydrogenase inhibitor fungicide in an amount ranging from 50 to 75 g ai/ha,
(ii) a demethylation inhibitor fungicide in an amount ranging from 85 to 125 g ai/ha, and
(iii) a multi-site fungicide in an amount ranging from 800 to 1200 g ai/ha.

In an embodiment, the present disclosure relates to a method of controlling Puccinia striiformis infestation in wheat crop, the method comprising applying to a plant or to a locus of a plant or a plant propagation thereof, a fungicidal combination comprising;
(i) a succinate dehydrogenase inhibitor fungicide in an amount ranging from 10 to 300 g ai/ha,
(ii) a demethylation inhibitor fungicide in an amount ranging from 20 to 250 g ai/ha, and
(iii) a multi-site fungicide in an amount ranging from 500 to 2000 g ai/ha.

In an embodiment, the present disclosure relates to a method of controlling Puccinia striiformis infestation in wheat crop, the method comprising applying to a plant or to a locus of a plant or a plant propagation thereof, a fungicidal combination comprising;
(i) a succinate dehydrogenase inhibitor fungicide in an amount ranging from 50 to 150 g ai/ha,
(ii) a demethylation inhibitor fungicide in an amount ranging from 50 to 200 g ai/ha, and
(iii) a multi-site fungicide in an amount ranging from 500 to 1500 g ai/ha.

In an embodiment, the present disclosure relates to a method of controlling Puccinia striiformis infestation in wheat crop, said method comprising applying to a plant or to a locus of a plant or a plant propagation thereof, a fungicidal combination comprising;
(i) a succinate dehydrogenase inhibitor fungicide in an amount ranging from 50 to 75 g ai/ha,
(ii) a demethylation inhibitor fungicide in an amount ranging from 85 to 125 g ai/ha, and
(iii) a multi-site fungicide in an amount ranging from 800 to 1200 g ai/ha.

In an embodiment, the present disclosure relates to a method for controlling fungal infestation in wheat crop, the method comprising applying to a plant or to a locus of a plant or a plant propagation thereof, a fungicidal combination comprising;
(i) fluxapyroxad in an amount ranging from 10 to 300 g ai/ha,
(ii) prothioconazole in an amount ranging from 20 to 250 g ai/ha, and
(iii) mancozeb in an amount ranging from 500 to 2000 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) fluxapyroxad in an amount ranging from 50 to 150 g ai/ha,
(ii) prothioconazole in an amount ranging from 50 to 200 g ai/ha, and
(iii) mancozeb in an amount ranging from 500 to 1500 g ai/ha.

In an embodiment, the present disclosure relates to a method of controlling fungal infestation in wheat crop, the method comprising applying to a plant or to a locus of a plant or a plant propagation thereof, a fungicidal combination comprising;
(i) fluxapyroxad in an amount ranging from 50 to 75 g ai/ha,
(ii) prothioconazole in an amount ranging from 85 to 125 g ai/ha, and
(iii) mancozeb in an amount ranging from 800 to 1200 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) fluxapyroxad in an amount ranging from 10 to 300 g ai/ha,
(ii) prothioconazole in an amount ranging from 20 to 250 g ai/ha, and
(iii) mancozeb in an amount ranging from 500 to 2000 g ai/ha.

In an embodiment, the present disclosure relates to a method of controlling Pyrenophora tritici infestation in wheat crop, the method comprising applying to a plant or to a locus of a plant or a plant propagation thereof, a fungicidal combination comprising;
(i) fluxapyroxad in an amount ranging from 50 to 150 g ai/ha,
(ii) prothioconazole in an amount ranging from 50 to 200 g ai/ha, and
(iii) mancozeb in an amount ranging from 500 to 1500 g ai/ha.

In an embodiment, the present disclosure relates to a method of controlling Pyrenophora tritici infestation in wheat crop, said method comprising applying to a plant or to a locus of a plant or a plant propagation thereof, a fungicidal combination comprising;
(i) fluxapyroxad in an amount ranging from 50 to 75 g ai/ha,
(ii) prothioconazole in an amount ranging from 85 to 125 g ai/ha, and
(iii) mancozeb in an amount ranging from 800 to 1200 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount ranging from 10 to 300 g ai/ha,
(ii) prothioconazole in an amount ranging from 20 to 250 g ai/ha, and
(iii) mancozeb in an amount ranging from 500 to 2000 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount ranging from 50 to 150 g ai/ha,
(ii) prothioconazole in an amount ranging from 50 to 200 g ai/ha, and
(iii) mancozeb in an amount ranging from 500 to 1500 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount ranging from 50 to 75 g ai/ha,
(ii) prothioconazole in an amount ranging from 85 to 125 g ai/ha, and
(iii) mancozeb in an amount ranging from 800 to 1200 g ai/ha.

In an embodiment, the present disclosure relates to a method of controlling Puccinia striiformis infestation in wheat crop, the method comprising applying to a plant or to a locus of a plant or a plant propagation thereof, a fungicidal combination comprising;
(i) fluxapyroxad in an amount ranging from 10 to 300 g ai/ha,
(ii) prothioconazole in an amount ranging from 20 to 250 g ai/ha, and
(iii) mancozeb in an amount ranging from 500 to 2000 g ai/ha.

In an embodiment, the present disclosure relates to a method of controlling Puccinia striiformis infestation in wheat crop, the method comprising applying to a plant or to a locus of a plant or a plant propagation thereof, a fungicidal combination comprising;
(i) fluxapyroxad in an amount ranging from 50 to 150 g ai/ha,
(ii) prothioconazole in an amount ranging from 50 to 200 g ai/ha, and
(iii) mancozeb in an amount ranging from 500 to 1500 g ai/ha.

In an embodiment, the present disclosure relates to a method of controlling Puccinia striiformis infestation in wheat crop, the method comprising applying to a plant or to a locus of a plant or a plant propagation thereof, a fungicidal combination comprising;
(i) fluxapyroxad in an amount ranging from 50 to 75 g ai/ha,
(ii) prothioconazole in an amount ranging from 85 to 125 g ai/ha, and
(iii) mancozeb in an amount ranging from 800 to 1200 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount 89 g ai/ha, and
(ii) prothioconazole in an amount of 130 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount 50 g ai/ha,
(ii) prothioconazole in an amount of 80 g ai/ha, and
(iii) mancozeb in an amount of 900 g ai/ha.

In an embodiment, the present disclosure relates to a method of controlling Septoria tritici infestation in wheat crop, the method comprising applying to a plant or to a locus of a plant or a plant propagation thereof, a fungicidal combination comprising;
(i) fluxapyroxad in an amount 62.5 g ai/ha,
(ii) prothioconazole in an amount of 100 g ai/ha, and
(iii) mancozeb in an amount of 1125 g ai/ha.

The combinations of the present disclosure may be developed as a premix or tank-mix composition or a kit of parts such that individual actives may be mixed before applying. The present combinations/compositions can be applied to fungi or their locus by the use of conventional ground sprayers, granule applicators, and by other conventional means known to those skilled in the art.

According to an embodiment of the present disclosure, a kit-of-parts comprising a fungicide composition is provided. The kit comprises a plurality of components, each of which components may include at least one of the ingredients of the fungicide composition of the present disclosure.

An embodiment of the present invention discloses a kit-of-parts comprising a succinate dehydrogenase inhibitor fungicide, a demethylation inhibitor fungicide, a multisite fungicide and/or agrochemically acceptable excipient. An embodiment of the present invention discloses a kit-of-parts comprising fluxapyroxad, prothioconazole, mancozeb and/or agrochemically acceptable excipient.

One or more of the components may already be combined or pre-formulated. In those embodiments where more than two components are provided in a kit, the components may already be combined and as such are packaged in a single container such as a vial, bottle, can, pouch, bag, or canister.

The advantages and other parameters of the present invention is illustrated by the below given examples. However, the scope of the present invention is not limited by the examples in any manner. It will be appreciated by any person skilled in this art that the present invention includes aforesaid examples and further can be modified and altered within the technical scope of the present invention.

### EXAMPLES

### Colby Value Determination:

A frequently used method for improving the activity of an agrochemical is the combination of an active compound with one or more other active compounds which contribute to the desired additional properties. However, when two or more active compounds are applied in combination, it may result in physical and biological incompatibility, for example insufficient stability of a formulation, decomposition of an active compound or antagonism of the active compounds. What is desired, in contrast, are active compound combinations having a favorable activity profile, high stability and, if possible, synergistically enhanced activity, thus permitting the application rate to be reduced, compared with the individual application of the active compounds to be combined.

Chemical mixtures can have an antagonistic effect when mixed, where the results are less than expected when the chemicals are combined. There can also be an additive effect, where the resultant mixture gives results expected from the sum of its components. Finally, there can be a synergistic effect where the results are greater than expected. A synergistic result is rare and typically only observed in results from high concentrations. In the heavily regulated agrochemical industry, high concentrations are not desirable in the environment. Therefore, when a synergistic effect is achieved at low doses, the resultant mixture is indeed a rare and unexpected finding.

A synergistic effect of an agrochemical is always present when the herbicidal activity of the active compound combinations exceeds the total of the activities of the active compounds when applied individually. The expected activity for a given combination of two active compounds can be calculated according to S. R. Colby (“Calculating Synergistic and Antagonistic Responses of Herbicide Combinations”, Weeds 15, (1967), 20-22).

Colby's equation was used to determine the herbicidal effects expected from the mixtures (Colby, S. R. Weeds 1967, 15, 20-22.m, Calculation of the synergistic and antagonistic response of herbicide combinations).

The following formula was used to calculate the expected activity of mixtures containing active ingredients, A and B:

$$Expected ( E ) = A + B - AB / 100$$

where A=observed efficacy of active ingredient A at the same concentration as used in the mixture.
B=observed efficacy of active ingredient B at the same concentration as used in the mixture.

In the Colby method, the expected (or predicted) response of a combination of fungicides is calculated by taking the product of the observed response for each individual component of the combination when applied alone divided by 100 and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective.

Thus, when the combination of the present invention was analysed using this method, it demonstrated an observed-expected value of greater than zero which is indicative of an unexpected efficacy. The basis of demonstration of unexpected efficacy by comparison with the Colby formula is that fungicide (A) tested alone would kill a proportion of the target fungal pest and leave the remaining portion (a %) as survivors. Similarly, fungicide B tested alone will leave (b %) as survivors. When combined, A+B will, act independently on the target fungal pest (if unexpected activity is absent); component A leaving a % survivors, which survivors will be controlled by component B; which has an overall effect of a %*b %*100. Subsequently, if the percent control is greater than that predicted by the Colby formula or stated conversely, if the difference between the observed control and the expected control is greater than zero; then unexpected enhancement in activity is acknowledged. The degree to which the difference is greater than zero is not itself critical as long as it is greater than zero; however greater the difference, more significant is the enhancement or the unexpectedness in phytopathogenic fungal control.

The following examples demonstrate the present invention. The examples should not be construed as limiting and are simply illustrations of many embodiments described herein.

### Example 1: Efficacy of the Fungicidal Combination of Fluxapyroxad and Prothioconazole Against Zymoseptoria tritici (SEPTTR) on Wheat

Efficacy of the combination of prothioconazole and fluxapyroxad was determined against Zymoseptoria tritici (Septoria tritici) in wheat crop. The actives prothioconazole and fluxapyroxad were tank mixed and applied as per the table below. Prothioconazole and fluxapyroxad were emulsifiable concentrate formulations with formulation concentrations of 250 g/L and 62.5 g/L, respectively. The applications were made twice at stages ‘A and ‘B’. Stage A was the time at which the first node was at least 1 cm above tillering node (Feekes 6.0=First node visible). Stage ‘B’ was the Flag leaf stage, wherein the flag leaf fully unrolled and ligule was visible (Feekes 9.0=Flag leaf). Applications were made at stage B which was 18 days after application A. The observations were made at 19 DA-A (19 days after application-A) as observed in table 1 (b) and at 23 DA-B (23 days after application B) as observed in Table 1 (c).

TABLE 1(a)
Treatment protocol

| | | Form | Application | Application |
|---|---|---|---|---|
| Trt. | | Conc. | rate | amount |
| No. | Treatment | (g/L) | mL/ha | g A/ha |
| 1 | Untreated Check | — | — | — |
| 2 | Prothioconazole | 250 | 520 | 130 |
| 3 | Fluxapyroxad | 62.5 | 1424 | 89 |
| 4 | Prothioconazole | 250 | 520 | 130 |
| | Fluxapyroxad | 62.5 | 1424 | 89 |

TABLE 1(b)
% control of Septoria tritici at 19 DA-A

| Trt | | Rate | % Observed | % Expected |
|---|---|---|---|---|
| No. | Treatment | mL/ha | Control | control |
| 1 | Untreated Check | — | 0.0 | — |
| 2 | Prothioconazole | 520 | 23.7 | — |
| 3 | Fluxapyroxad | 1424 | 25.6 | — |
| 4 | Prothioconazole | 520 | 67.6 | 43.23 |
| | Fluxapyroxad | 1424 | | |

TABLE 1(c)
% control of Septoria tritici at 23 DA-B

| Trt | | Rate | % Observed | % Expected |
|---|---|---|---|---|
| No. | Treatment | mL/ha | Control | control |
| 1 | Untreated Check | — | 0.0 | — |
| 2 | Prothioconazole | 520 | 20.0 | — |
| 3 | Fluxapyroxad | 1424 | 37.8 | — |
| 4 | Prothioconazole | 520 | 85.5 | 50.24 |
| | Fluxapyroxad | 1424 | | |

The combination of prothioconazole and fluxapyroxad proved to be synergistic in the control of Zymoseptoria tritici (Septoria tritici). The observed control % of the fungal pathogen was greater than the expected control % calculated by Colby's formula. Therefore, the combination of fluxapyroxad and prothioconazole is synergistic.

### Example 2: Efficacy of the Fungicide Combination of Fluxapyroxad, Prothioconazole and Mancozeb on Yellow Rust

The efficacy of the fluxapyroxad, prothioconazole and mancozeb on yellow rust caused by Puccinia striiformis, in wheat cultivations was evaluated.

TABLE 2
Treatment protocol

| | | Active | For- | | |
|---|---|---|---|---|---|
| | | ingredient | mulation | | |
| | | dose | dose | | Yield |
| No. | Treatment | (g/ha) | g/ha | % Control | (kg/ha) |
| 1. | Untreated | — | — | — | 6106 |
| 2. | Fluxapyroxad + | 50.1 + 80 + | 151.9 + | 99.1 | 7119.25 |
| | Prothioconazole + | 900 | 200 + | | |
| | Mancozeb | | 1200 | | |
| 3. | Fluxapyroxad + | 62.5 + 100 + | 189.4 + | 98.6 | 6898.75 |
| | Prothioconazole + | 1125 | 250 + | | |
| | Mancozeb | | 1500 | | |

It is evident from the above data that the application of the combination of fluxapyroxad, prothioconazole and mancozeb provided an efficacious control of the target phytopathogen Puccinia striiformis. The increase in wheat yield is also indicative of the efficacy of the combination.

1. A fungicidal combination for controlling fungal infestation in wheat crop comprising fluxapyroxad and prothioconazole.

2. The combination as claimed in claim 1, wherein fluxapyroxad and prothioconazole are in a ratio ranging from 1:10 to 10:1.

3. The combination as claimed in claim 1, further comprising a multi-site fungicide selected from mancozeb, copper salts, sulphur, ferbam, maneb, metiram, propineb, thiram, zinc thiazole, zineb, ziram, captan, captafol, folpet, chlorothalonil, dichlofluanid, tolylfluanid, guazatine, iminoctadine, anilazine, dithianon, chinomethionat/quinomethionate, fluoroimide, and methasulfocarb.

4. The combination as claimed in claim 3, wherein the weight ratio of fluxapyroxad, prothioconazole, and mancozeb is in a ratio ranging from 1:1:25 to 25:3:1.

5. The combination as claimed in claim 1, wherein the fungal infestation is caused by Septoria tritici, Puccinia spp., Puccinia recondite, Puccinia striiformis; Drechslera tritici-repentis, Pyrenophora teres, Leptosphaeria nodorum, or Stagonospora nodorum.

6. The combination as claimed in claim 1, the combination comprising;
(i) the fluxapyroxad in an amount ranging from 10 to 300 g ai/ha, and
(ii) the prothioconazole in an amount ranging from 10 to 500 g ai/ha.

7. The combination as claimed in claim 3, the combination comprising;
(i) the fluxapyroxad in an amount ranging from 10 to 300 g ai/ha,
(ii) the prothioconazole in an amount ranging from 20 to 250 g ai/ha, and
(iii) mancozeb in an amount ranging from 500 to 2000 g ai/ha.

8. A method of controlling fungal infestation in wheat crop comprising applying the fungicidal combination of claim 1 to a plant, a locus of a plant, or a plant propagation thereof, the combination comprising;
(i) the fluxapyroxad in an amount ranging from 10 to 300 g ai/ha, and
(ii) the prothioconazole in an amount ranging from 10 to 500 g ai/ha.

9. The method as claimed in claim 8, wherein the fungicidal combination comprises:
(i) the fluxapyroxad in an amount ranging from 20 to 150 g ai/ha, and
(ii) the prothioconazole in an amount ranging from 20 to 300 g ai/ha.

10. The method as claimed in claim 8, wherein the fungicidal combination further comprises an additional fungicide.

11. The method as claimed in claim 10, wherein the additional fungicide comprises a multi-site fungicide selected from mancozeb, copper salts, sulphur, ferbam, maneb, metiram, propineb, thiram, zinc thiazole, zineb, ziram, captan, captafol, folpet, chlorothalonil, dichlofluanid, tolylfluanid, guazatine, iminoctadine, anilazine, dithianon, chinomethionat/quinomethionate, fluoroimide, and methasulfocarb.

12. The method as claimed in claim 11, wherein the fungicidal combination comprises:
(i) the fluxapyroxad in an amount ranging from 10 to 300 g ai/ha,
(ii) the prothioconazole in an amount ranging from 20 to 250 g ai/ha, and
(iii) mancozeb in an amount ranging from 500 to 2000 g ai/ha.

13. The method as claimed in claim 11, wherein the fungicidal combination comprises:
(i) the fluxapyroxad in an amount ranging from 50 to 75 g ai/ha,
(ii) the prothioconazole in an amount ranging from 85 to 125 g ai/ha, and
(iii) mancozeb in an amount ranging from 800 to 1200 g ai/ha.

14. The method as claimed in claim 8, wherein the fungal infestation is caused by Septoria tritici, Puccinia spp., Puccinia recondite, Puccinia striiformis; Drechslera tritici-repentis and Pyrenophora teres, Leptosphaeria nodorum, or Stagonospora nodorum.

15. Use of a fungicidal combination for controlling fungal infestation in wheat crop, the combination comprising fluxapyroxad and prothioconazole.

16. Use of a fungicidal combination for controlling fungal infestation in wheat crop, the combination comprising fluxapyroxad, prothioconazole and mancozeb.
